(19) United States
(12) Patent Application Publication
(10) Pub. No.: US 2023/0419433 A1
(43) Pub. Date: Dec. 28, 2023

(54) AUTO-REPORTING PUBLIC MUSIC PERFORMANCES WITH SETLISTS

(71) Applicant: MULTITRACKS.COM, LLC, Cedar Park, TX (US)

(72) Inventor: Phillip Dean Edwards, Cedar Park, TX (US)

(73) Assignee: MULTITRACKS.COM, LLC, Cedar Park, TX (US)

(21) Appl. No.: 18/342,459

(22) Filed: Jun. 27, 2023

Related U.S. Application Data
(60) Provisional application No. 63/356,001, filed on Jun. 27, 2022.

(51) Int. Cl. G06Q 50/18; G06F 16/61

(52) U.S. Cl. CPC G06Q 50/184; G06F 16/61

(57) ABSTRACT

Systems and methods auto-reporting public music performances. The method includes generating an instance of a data structure for a music setlist that will be performed during a public performance. The method also includes adding, to the instance of the data structure, a performance date for the music setlist. The method further includes receiving, from a user, a master audio recording of a song to add to the music setlist. The method also includes adding, to the instance of the data structure, a master identifier indicating a first entity that owns the master audio recording. The method further includes adding, to the instance of the data structure, a publishing identifier indicating a second entity that owns publishing rights to the song. The method also includes automatically reporting the music setlist after a predetermined period of time following the performance date.

### CROSS-REFERENCE TO RELATED APPLICATION

This application claims priority to and the benefit of U.S. Provisional Application Ser. No. 63/356,001 filed Jun. 27, 2022, titled “AUTO-REPORTING MUSIC USAGE WITH SETLISTS,” the entire disclosure of which is hereby incorporated by reference for all purposes.

### BACKGROUND

During services and other public events, churches and other religious institutions often sing and/or play copyrighted music. In addition, churches may stream copyrighted music over the Internet. Further, to enable participants to follow along, churches may project, stream, or print lyrics of copyrighted songs. To comply with copyright laws, churches are required to license any reproduction of copyrighted music being both masters and underlying copyrights. The performance of any copyright music in a church service is exempt via the religious exemption terms of copyright law. Churches are required to provide usage information to relevant owners or a Collective Management Organization (CMO). The CMO distributes royalty payments to copyright holders of the music. However, to determine which copyright holders to pay and how much each copyright holder receives, the CMO needs churches to report their music usage.

### SUMMARY

Currently, churches and other religious institutions manually report their music usage. For practical reasons, churches do not manually report their music usage on a continuous basis (e.g., weekly). Rather, churches are chosen by particular licensing organization to manually report their music reproduction or usage retrospectively for a period of time. For example, every six months a church may be selected to manually report their music usage for the previous six months. Manual, retrospective reporting of music usage provides only a proportional representation of actual music usage. Determining royalties using this type of reporting often results in payments that do not accurately reflect actual music usage. Thus, various examples of the present disclosure are directed to systems and methods of automatically reporting public music performances. More particularly, various examples of the present disclosure are directed to systems and methods that use setlists to auto-report lyric, song reproductions, and master recording usage in an online stream for both stereo recordings and stems or multitrack recordings.

The present disclosure provides a method for auto-reporting public music performances. The method includes generating an instance of a data structure for a music setlist that will be performed during a public performance. The method also includes adding, to the instance of the data structure, a performance date for the music setlist. The method further includes receiving, from a user, a first master audio recording of a first song to add to the music setlist. The method also includes adding, to the instance of the data structure, a first master identifier indicating a first entity that owns the first master audio recording. The method further includes adding, to the instance of the data structure, a first publishing identifier indicating a second entity that owns publishing rights to the first song. The method also includes receiving, from the user, a second master audio recording of a second song to add to the music setlist. The method further includes adding, to the instance of the data structure, a second master identifier indicating a third entity that owns the second master audio recording. The method also includes adding, to the instance of the data structure, a second publishing identifier indicating a fourth entity that owns publishing rights to the second song. The method further includes automatically reporting the music setlist after a predetermined period of time following the performance date.

The present disclosure also provides a system for auto-reporting public music performances. The system includes, in one implementation, one or more memory devices and one or more processing devices. The one or more memory devices are for storing instructions. The one or more processing devices are configured to execute the instructions to generate an instance of a data structure for a music setlist that will be performed during a public performance. The one or more processing devices are also configured to execute the instructions to add, to the instance of the data structure, a performance date for the music setlist. The one or more processing devices are further configured to execute the instructions to receive, from a user, a first master audio recording of a first song to add to the music setlist. The one or more processing devices are also configured to execute the instructions to add, to the instance of the data structure, a first master identifier indicating a first entity that owns the first master audio recording. The one or more processing devices are further configured to execute the instructions to add, to the instance of the data structure, a first publishing identifier indicating a second entity that owns publishing rights to the first song. The one or more processing devices are also configured to execute the instructions to receive, from the user, a second master audio recording of a second song to add to the music setlist. The one or more processing devices are further configured to execute the instructions to add, to the instance of the data structure, a second master identifier indicating a third entity that owns the second master audio recording. The one or more processing devices are also configured to execute the instructions to add, to the instance of the data structure, a second publishing identifier indicating a fourth entity that owns publishing rights to the second song. The one or more processing devices are further configured to execute the instructions to automatically report the music setlist after a predetermined period of time following the performance date.

Other technical features may be readily apparent to one skilled in the art from the following figures and descriptions.

### BRIEF DESCRIPTION OF THE DRAWINGS

For a more complete understanding of the present disclosure and its advantages, reference is now made to the following description, taken in conjunction with the accompanying drawings. It is emphasized that, according to common practice, the various features of the drawings are not necessarily to-scale. On the contrary, the dimensions of the various features may be—and typically are—arbitrarily expanded or reduced for the purpose of clarity.

FIG. 1 is a screen shot of an example of a graphical user interface (GUI) for a music setlist for a Sunday morning service, in accordance with some implementations of the present disclosure.

FIG. 2 is a flow diagram of an example of a method for auto-reporting public music performances, in accordance with some implementations of the present disclosure.

FIG. 3 is a screen shot of an example of a GUI for creating a music setlist, in accordance with some implementations of the present disclosure.

FIG. 4 is a screen shot of an example of a GUI for importing setlist and service data from a third-party planning system, in accordance with some implementations of the present disclosure.

FIG. 5A is a block diagram of an example of a data structure for a music setlist, in accordance with some implementations of the present disclosure.

5B is a block diagram of an example of a data structure for an organization, in accordance with some implementations of the present disclosure.

FIG. 5C is a block diagram of an example of a data structure for a record update, in accordance with some implementations of the present disclosure.

FIG. 6 is a block diagram of an example of data structures included in a system for a-auto-reporting public music performances that includes cloud songs, in accordance with some implementations of the present disclosure.

FIG. 7 is a block diagram of an example of a system for auto-reporting public music performances, in accordance with some implementations of the present disclosure.

FIG. 8 is a block diagram of an example of a computer system, in accordance with some implementations of the present disclosure.

FIG. 9 is a block diagram of an example of a data structure for a music setlist, in accordance with some implementations of the present disclosure.

FIG. 10 is a flow diagram of an example of a method for auto-reporting public music performances, in accordance with some implementations of the present disclosure.

### NOTATION AND NOMENCLATURE

Various terms are used to refer to particular system components. A particular component may be referred to commercially or otherwise by different names. Further, a particular component (or the same or similar component) may be referred to commercially or otherwise by different names. Consistent with this, nothing in the present disclosure shall be deemed to distinguish between components that differ only in name but not in function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

The terminology used herein is for the purpose of describing particular example implementations only, and is not intended to be limiting. As used herein, the singular forms “a,” “an,” “the,” and “said” may be intended to include the plural forms as well, unless the context clearly indicates otherwise. The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one processor configured to perform actions A, B, and C. In addition, “A processor” configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example implementations. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “up,” “upper,” “top,” “bottom,” “down,” “inside,” “outside,” “contained within,” “superimposing upon,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

“Real-time” may refer to less than or equal to 2 seconds. “Near real-time” may refer generally to less than 10 seconds (or any suitable proximate difference between two different times) but greater than 2 seconds.

“Entity” as used herein may refer to an individual, a group of individuals, a company, or a business.

### DETAILED DESCRIPTION

The following discussion is directed to various implementations of the present disclosure. Although one or more of these implementations may be preferred, the implementations disclosed should not be interpreted, or otherwise used, as limiting the scope of the present disclosure. In addition, one skilled in the art will understand that the following description has broad application, and the discussion of any implementation is meant only to be exemplary of that implementation, and not intended to intimate that the scope of the disclosure is limited to that implementation.

A Collective Management Organization (CMO) is an agency that ensures songwriters and publishers are paid for the use of their music by collecting royalties on behalf of the rights owner. A CMO collects reproduction and performance based royalties. When a song is played in public (for example, on a radio (e.g., AM/FM, streaming, and satellite), in a venue, or TV shows and commercials) it is required that they pay for the reproduction and performance of the underlying copyright work. A CMO collects those payments, and distributes them to the rights holders. Currently, churches and other religious institutions manually report their music usage to relevant CMO's retrospectively for an extended period of time. For example, a representative for the church may manually enter the names of each song they played during the last six-months into a form that is submitted to a CMO. Manual, retrospective reporting of song usage provides only a proportion representation of actual music usage. For example, most churches essentially guess how many times each time song was played. Thus, various examples of the present disclosure are directed to systems and methods of automatically reporting public music performances. More particularly, various examples of the present disclosure are directed to systems and methods that use setlists to auto-report lyric, song reproductions, and master recording usage in an online stream for both stereo recordings and stems or multitrack recordings.

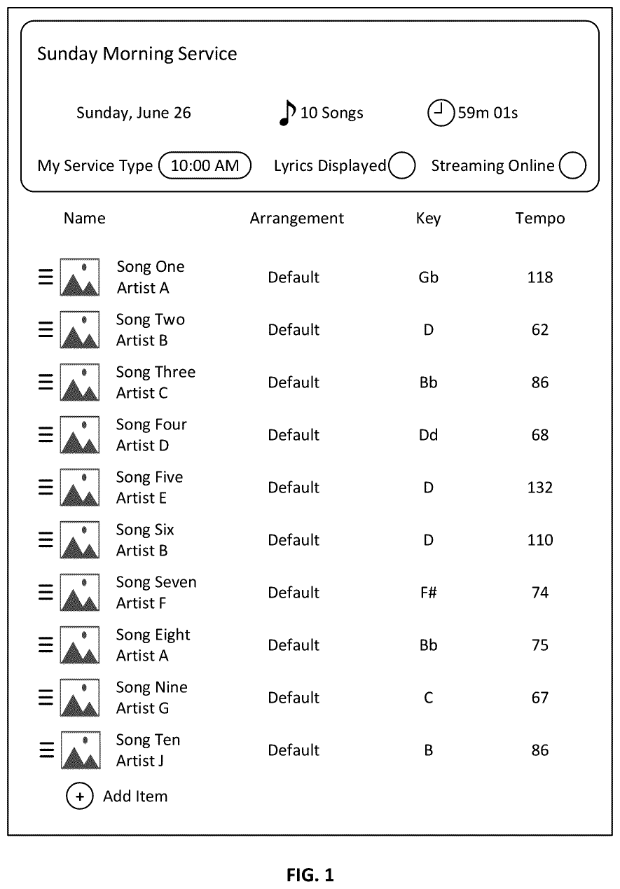

To sing, play, stream, and/or project lyrics of songs during a public performance, a user adds the songs to a music setlist. FIG. 1 is a screen shot of an example of a graphical user interface (GUI) for a music setlist for a Sunday morning service. The music setlist includes a performance date indicating the date of a public performance in which this music setlist will be used. For example, the GUI of the music setlist illustrated in FIG. 1 indicates that this music setlist will be played on Sunday, June 26. In some implementations, the performance date is set on a per-setlist basis. For example, a user may manually provide the performance date for each music setlist. Alternatively, or in addition, the performance date is set based on a service type associated with a music setlist. For example, a user may tag a music setlist as a Sunday morning service and performance date is set to the date of the upcoming Sunday. The GUI of the music setlist illustrated in FIG. 1 also includes a list of songs that will be played during the Sunday morning service. In some implementations, the music setlist includes indications of whether each song will be performed live or a recording will be used. For example, a live band may play some of the songs, some songs may be sung without instrumental accompaniment, and tracks of other songs may be played over speakers. Alternatively, or in addition, the music setlist includes indications of whether the song lyrics will be displayed (e.g., projected on a screen, printed on a song sheet, or both). For example, the GUI of the music setlist illustrated in FIG. 1 indicates that the song lyrics will be projected. Alternatively, or in addition, the music setlist may include an indication of whether the songs will played to a live audience, streamed over the Internet, or both. Alternatively, or in addition, the music setlist may include information for each song listed. For example, the GUI of the music setlist illustrated in FIG. 1 indicates whether the default arrangement of each song will be used, the musical key of each song, and the tempo of each song.

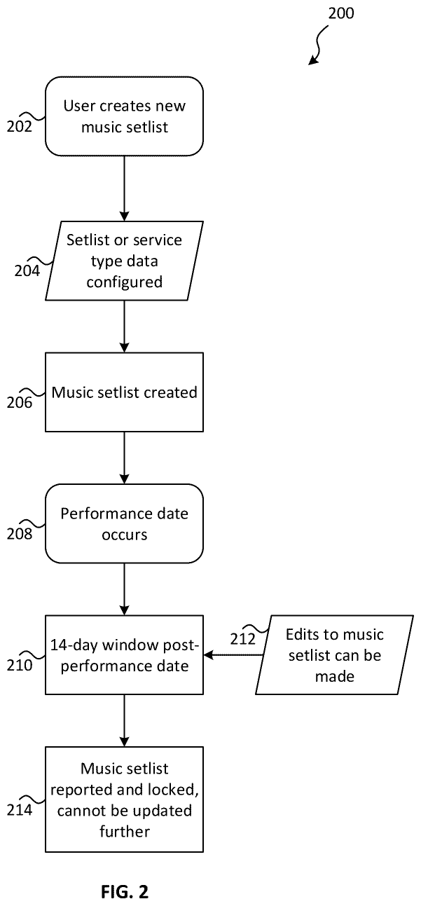

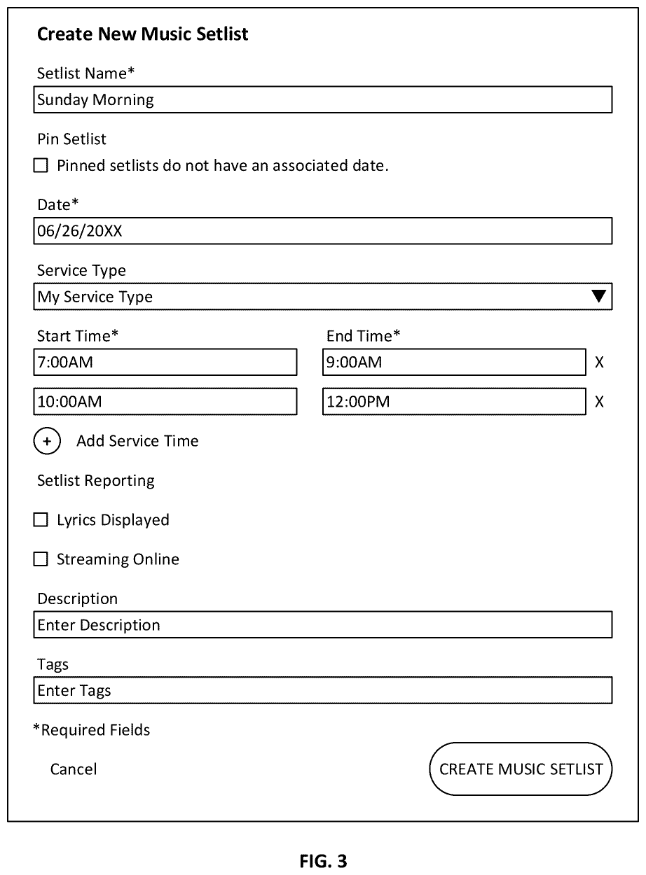

FIG. 2 is a flow diagram of an example of a method 200 for auto-reporting public music performances. At block 202, a user creates a new music setlist. FIG. 3 is a screen shot of an example of a GUI for creating a music setlist. As illustrated in FIG. 3, a user may provide a name for the music setlist, one or more tags for the music setlist (e.g., adult service, kids service, or midweek service), a description of the music setlist, an indication of the service type, and the times and attendances of the services. For example, the GUI illustrated in FIG. 3 indicates that the music setlist is for Sunday morning service that take place at 7:00 AM and 10:00 AM.

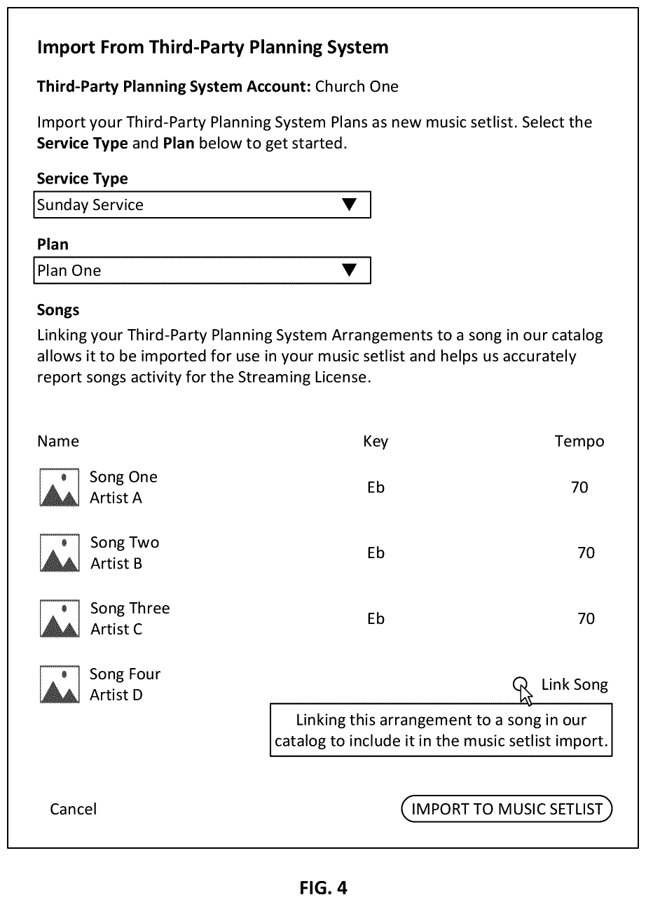

Returning to FIG. 2, at block 204, a setlist or service type data is configured. In some implementations, the setlist or service type data is configured internally. For example, the setlist or service type data may be configured within a website provided by a music usage reporting system. Alternatively, or in addition, the setlist or service type data is imported from an external source. For example, the setlist or service type data may be imported from a music plan generated by (or within) a third-party planning system. FIG. 4 is a screen shot of an example of a GUI for importing setlist and service data from a third-party planning system. As part of configuring the setlist or service type data, a performance date is added to the music setlist. The performance date indicates the date of a public performance in which the music setlist will be performed.

Returning to FIG. 2, at block 206, the music setlist is created. At block 208, the performance date occurs. During a 14-day window after the performance date at block 210, edits can be made to the music setlist at block 212. In some implementations, the post-performance date window for edits is longer or shorter than 14 days. The post-performance date window (an example of a “predetermined period of time following the performance date”) provides a buffer to allow edits to account for changes during the performance of the music setlist. For example, a church may sing a song that just happens in the moment and was not planned for or a leader may sing a refrain of a song. In some implementations, edits to the music setlist are made manually. For example, the user may enter the edits via a website provided by a music usage reporting system. Alternatively, or in addition, edits to the music setlist are imported from an external source. For example, the user may enter the edits via a website provided by a third-party planning system and the music setlist may sync to the third-party (e.g., once a day). At block 214, the music setlist is reported and locked, and the music setlist cannot be updated further. Locking the music setlist prevents users from going back and retrospectively changing the music setlist.

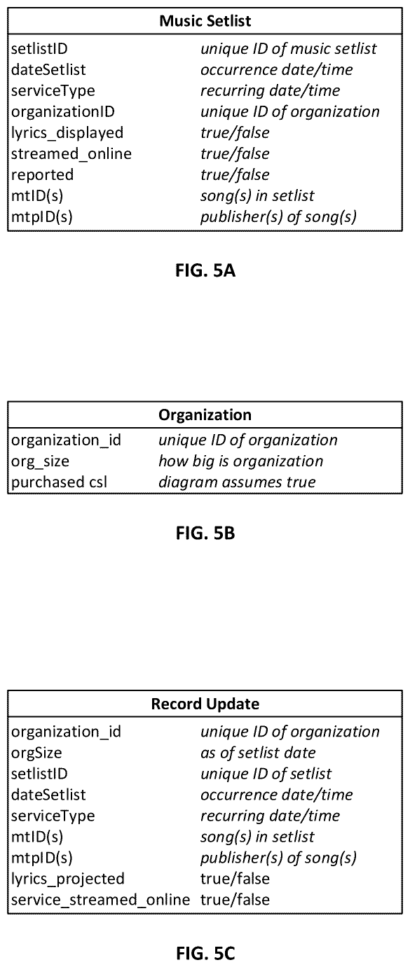

FIG. 5A is a block diagram of an example of a data structure for a music setlist. The data structure for a music setlist illustrated in FIG. 5A includes a plurality of variables. In some implementations, the data structure for the music setlist may include more variables, less variables, or different variables than the ones illustrated in FIG. 5A. In some implementations, the data structure for the music setlist illustrated in FIG. 5A is stored in one or more SQL tables (e.g., in a database).

The data structure for the music setlist illustrated in FIG. 5A includes a variable named “setlistID” that uniquely identifies the music setlist. The data structure for the music setlist illustrated in FIG. 5A also includes a variable named “dateSetlist” that identifies a performance date for the music setlist. The data structure for the music setlist illustrated in FIG. 5A also includes a variable named “serviceType” that identifies the type of service the music setlist is intended for. For example, the “serviceType” variable may indicate that the music setlist is for a Sunday service that occurs multiple times every Sunday. The data structure for the music setlist illustrated in FIG. 5A also includes a variable named “organizationID” that uniquely identifies a specific organization or customer (e.g., a specific church) that will use the music setlist. The data structure for the music setlist illustrated in FIG. 5A also includes a variable named “lyrics displayed” that indicates when the song lyrics will be displayed during the public performance. In some implementations, the “lyrics displayed” variable further indicates whether the song lyrics will be projected (e.g., on a screen) or printed (e.g., on song sheets for the participants). The data structure for the music setlist illustrated in FIG. 5A also includes a variable named “streamed online” that indicates whether the music setlist will be streamed online. For example, the music setlist may be used during an in-person that is streamed online over the Internet. The data structure for the music setlist illustrated in FIG. 5A also includes a variable named “reported” that identifies whether the music setlist has been reported. As previously described, the music setlist cannot be altered once the setlist has been reported.

Some songs have multiple versions (or arrangements) that can be used. For example, a song may have a popular arrangement but there can be others arrangements with the exact same lyrics but different instrumentation. Each arrangement of a song is called a master (or master audio recording). Typically, a royalty for a specific master audio recording of a song is paid both to the author(s) of the song (or the owner/controller of the publishing rights) and to the owner of the original recording (or the owner of the master audio recording). For each song in the music setlist, the entity that owns the master audio recording of that song is identified in the data structure illustrated in FIG. 5A using a variable named “mtID” (referred to herein as “MT ID,” “MultiTracks ID,” or “master identifier”). Further, for each song in the music setlist, the entity that owns the publishing rights to that song is identified in the data structure illustrated in FIG. 5A using a variable named “mtpID” (referred to herein as “MTP ID,” “MultiTracks Publishing ID,” or “publishing identifier”). The same entity owns the publishing rights to a song for every master audio recording of that song. Thus, different master audio recordings of the same song will have different master identifiers, but the same publishing identifier. The master identifier and publishing identifier of a song can be used to determine the percentage of royalties that goes to the entity that owns the publishing rights to the song and the percentage of royalties that goes to the entity that owns the master audio recording of the song.

FIG. 5B is a block diagram of an example of a data structure for an organization. The data structure for the organization illustrated in FIG. 5B includes a plurality of variables. In some implementations, the data structure for the organization may include more variables, less variables, or different variables than the ones illustrated in FIG. 5B. In some implementations, the data structure for the organization illustrated in FIG. 5B is stored in one or more SQL tables (e.g., in a database).

The data structure for the organization illustrated in FIG. 5B includes the variable named “organizationID” that uniquely identifies a specific organization or customer (e.g., a specific church). In some implementations, the amount an organization (or customer) pays to obtain a license to use copyrighted music is determined based on the organization's size. For example, a church with more members will pay more than a church with less members. Thus, the data structure for the organization illustrated in FIG. 5B also includes a variable “orgSize” that indicates how big the organization is. For example, one organization may be a small church with 500 members and another customer may be a mega-church with 50,000 members. The data structure for the organization illustrated in FIG. 5B also includes a variable named “purchased csl” that indicates whether the organization has purchased a CSL (church steaming license).

In some implementations, when the music setlist is reported, a record update is generated. FIG. 5C is a block diagram of an example of a data structure for a record update. As illustrated in FIG. 5C, the data structure for the record update includes all the variables included in the data structure for the music setlist described above in relation to FIG. 5A as well as the “orgSize” variable from the data structure for the organization described above in relation to FIG. 5B. The value of “orgSize” included in the record update reflects the size of the organization as of the performance date of the music setlist in order to reflect the potential listenership of the music setlist when it is used. In some implementations, reporting is directly based on the music setlist. In some implementations, the data structure for the record update illustrated in FIG. 5C is stored in one or more SQL tables (e.g., in a database).

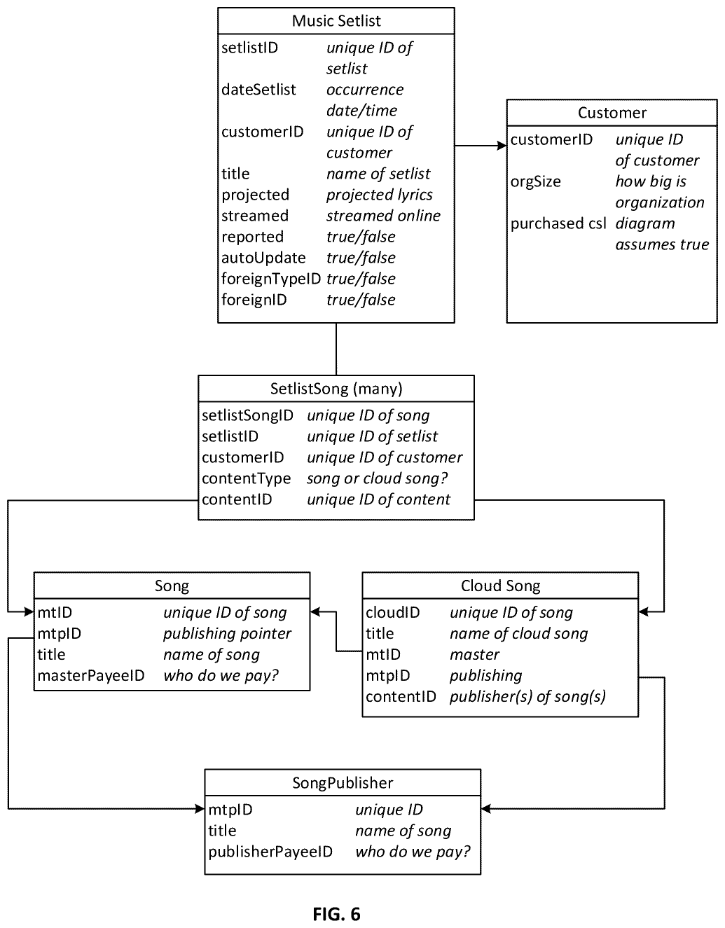

In some implementations, a user may add songs to a music setlist from a catalogue of songs provided by a music usage reporting system. In such implementations, the catalogue may include master identifiers and publishing identifiers for each song in the music setlist. Alternatively, or in addition, a user may add cloud songs to a music setlist. For example, a user may purchase a master audio recording from outside the music usage reporting system and add the master audio recording to the music usage reporting system as a cloud song. As a further example, a user may purchase a master audio recording from the music usage reporting system, remaster it, and upload the remaster as a cloud song. As an additional example, a user may perform an acoustic/original composition of an existing song and upload it as a cloud song. FIG. 6 is a block diagram of an example of data structures included in a system for auto-reporting reporting public music performances that includes cloud songs. As illustrated in FIG. 6, the setlistSong data structure includes a variable named “contentType” that indicates whether each song is a song (i.e., from the catalogue) or a cloud song. In some implementations, the music usage reporting system enables a user to link a cloud song to a song included in the catalogue of songs provided by the music usage reporting system. In some implementations, the music usage reporting system enables a user to add metadata to a cloud song using a simple song shell when the cloud song does not match any songs included in the catalogue.

As described above, the amount an organization (or customer) pays to obtain a license to use copyrighted music may be determined based on the organization's size. Alternatively, or in addition, the amount an organization pays to obtain a license to use copyrighted music may be determined based on the organization's music usage as reported by the music usage reporting system described herein. In some implementations, the system automatically generates reports of music usage at set intervals. For example, every quarter, the system may gather the last three months of song scheduling data in setlists in order to report payments to the publishers of the content. In some implementations, the music usage reporting system aggregates reported music usage across all organizations. For example, the music usage reporting system may report to a music label the number of times a particular song has been played by any of the organizations during the past month. Alternatively, or in addition, the music usage reporting system aggregates reported music usage across a particular region. For example, the music usage reporting system may report to a music label the number of times a particular song has been played by an organization in United States during the past three months.

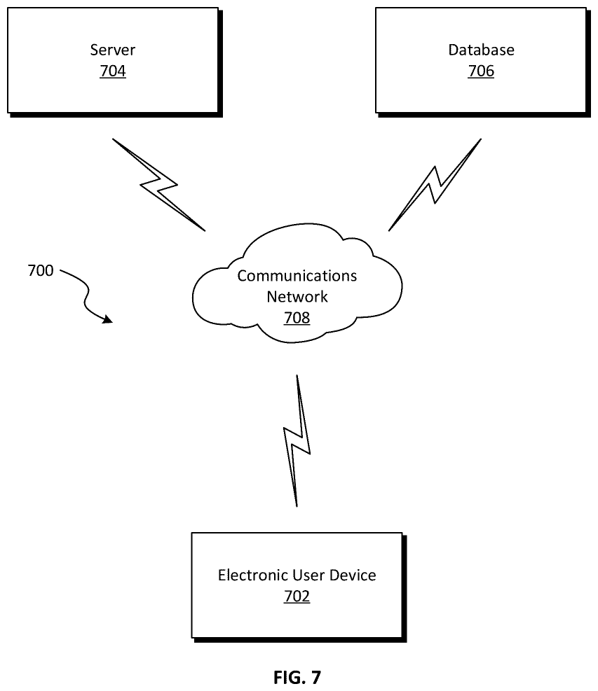

FIG. 7 is a block diagram of an example of a system 700 for auto-reporting public music performances. The system 700 illustrated in FIG. 7 includes an electronic user device 702, a server 704, a database 706, and a communications network 708. The system 700 may include fewer, additional, or different components in different configurations than the system 700 illustrated in FIG. 7. For example, in some implementations, the system 700 may include multiple electronic user devices. The electronic user device 702 may include a smartphone, a tablet, a laptop computer, a desktop computer, or a combination thereof. The communications network 708 may be a wired network, a wireless network, or both. All or parts of the communications network 708 may be implemented using various networks, for example, a cellular network, the Internet, a Bluetooth™ network, a wireless local area network (e.g., Wi-Fi), a wireless accessory Personal Area Networks (PAN), cable, an Ethernet network, satellite, a machine-to-machine (M2M) autonomous network, and a public switched telephone network. The electronic user device 702, the server 704, and the other various components of the system 700 communicate with each other over the communications network 708 using suitable wireless or wired communication protocols. In some implementations, communications with other external devices (not shown) occur over the communications network 708.

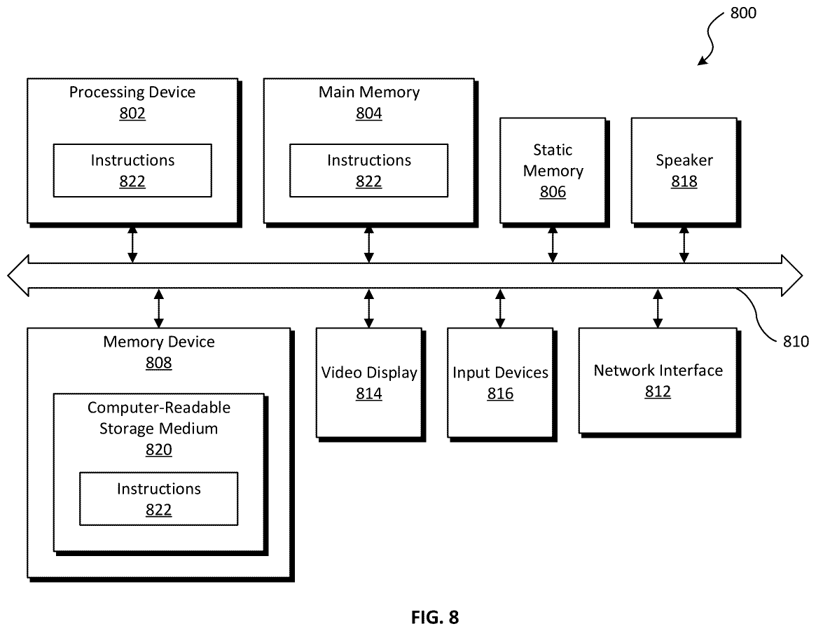

FIG. 8 is a block diagram of an example of a computer system 800. The computer system 800 may be connected (e.g., networked) to other computer systems in a LAN, an intranet, an extranet, or the Internet, including via the cloud or a peer-to-peer network. The computer system 800 may operate in the capacity of the electronic user device 702, the server 704, and/or the database 706 of the system 700 illustrated in FIG. 7. The computer system 800 may be a personal computer (PC), a tablet computer, a wearable (e.g., wristband), a set-top box (STB), a personal Digital Assistant (PDA), a mobile phone, a smartphone, a camera, a video camera, an Internet of Things (IoT) device, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 800 illustrated in FIG. 8 includes a processing device 802, a main memory 804 (e.g., read-only memory (ROM), flash memory, solid state drives (SSDs), dynamic random access memory (DRAM) such as synchronous DRAM (SDRAM)), a static memory 806 (e.g., flash memory, solid state drives (SSDs), static random access memory (SRAM)), and a memory device 808, which communicate with each other via a bus 810.

The processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a system on a chip, a field programmable gate array (FPGA), a digital signal processor (DSP), network processor, or the like. The processing device 802 may be configured to execute instructions for performing any of the operations and steps discussed herein.

The computer system 800 illustrated in FIG. 8 further includes a network interface device 812. The computer system 800 also may include a video display 814 (e.g., a liquid crystal display (LCD), a light-emitting diode (LED), an organic light-emitting diode (OLED), a quantum LED, a cathode ray tube (CRT), a shadow mask CRT, an aperture grille CRT, a monochrome CRT), input devices 816 (e.g., a keyboard and/or a mouse or a gaming-like control), and one or more speakers 818 (e.g., a speaker). In one illustrative example, the video display 814 and the input devices 816 may be combined into a single component or device (e.g., an LCD touch screen).

The memory device 808 may include a computer-readable storage medium 820 on which the instructions 822 embodying any one or more of the methods, operations, or functions described herein is stored. The instructions 822 may also reside, completely or at least partially, within the main memory 804 and/or within the processing device 802 during execution thereof by the computer system 800. As such, the main memory 804 and the processing device 802 also constitute computer-readable media. The instructions 822 may further be transmitted or received over a network via the network interface device 812.

While the computer-readable storage medium 820 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium capable of storing, encoding or carrying out a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods described herein may be performed by processing logic that may include hardware (circuitry, dedicated logic, etc.), software (such as is run on a general-purpose computer system, a dedicated machine, or a computing device of any kind (e.g., IoT node, wearable, smartphone, mobile device, etc.)), or a combination of both. The methods described herein and/or each of their individual functions (including “methods,” as used in object-oriented programming), routines, subroutines, or operations may be performed by one or more processors of a computing device (e.g., any component of FIG. 7, such as the server 704). In certain implementations, the methods described herein may be performed by a single processing thread. Alternatively, the methods described herein may be performed by two or more processing threads, wherein each thread implements one or more individual functions, routines, subroutines, or operations of the methods described herein.

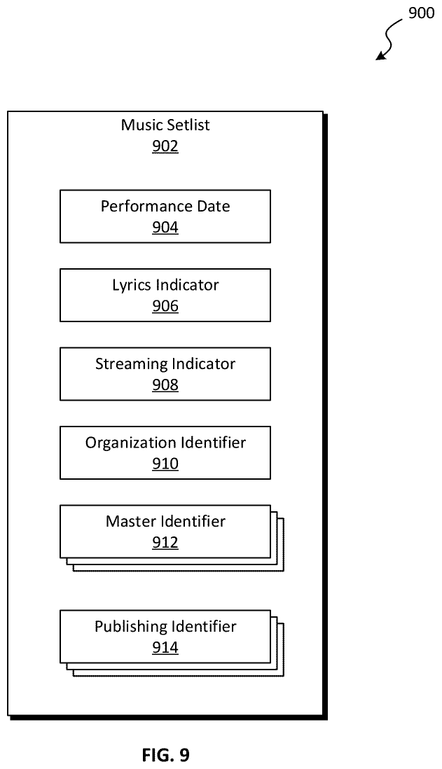

FIG. 9 is a block diagram of an example of a data structure 900 for a music setlist 902. The data structure 900 illustrated in FIG. 9 includes a performance date 904, a lyrics indicator 906, a streaming indicator 908, an organization identifier 910, one or more master identifiers 912 and one or more publishing identifiers 914. In some implementations, the data structure 900 for the music setlist 902 may include more component, less components, or different components than the ones illustrated in FIG. 9.

The performance date 904 indicates a date of a public performance at which the music setlist 902 will be performed. In some implementations, the performance date 904 includes the variable named “dateSetlist” that was previously described above. The lyrics indicator 906 indicates whether song lyrics will be displayed during the public performance. In some implementations, the lyrics indicator 906 indicates whether the song lyrics will be projected (e.g., on a screen) or printed (e.g., on song sheets for participants). In some implementations, the lyrics indicator 906 includes the variable named “lyrics displayed” that was previously described above. The streaming indicator 908 indicates whether the public performance will be steamed online (e.g., over the Internet). In some implementations, the streaming indicator 908 includes the variable named “streamed online” that was previously described above. The organization identifier 910 identifies an organization associated with the public performance. For example, the organization identifier 910 may uniquely identify a specific organization or customer (e.g., a specific church) that will use the music setlist 902 during a public performance. In some implementations, the organization identifier 910 includes the variable named “organizationID” that was previously described above.

A master identifier 912 and a publishing identifier 914 are added to the data structure 900 for each master audio recording that is added to the music setlist 902. For example, when the music setlist 902 includes ten songs, an instance of the data structure 900 for the music setlist 902 will includes ten master identifiers 912 and ten publishing identifier 914. Each master identifier 912 indicates an entity that owns a master audio recording of a song added to the music setlist 902. Further, each publishing identifier 914 indicates an entity that owns publishing rights to a song added to the music setlist 902. In some implementations, each master identifier 912 includes the variable named “mtID” that was previously described above. In some implementations, each publishing identifier 914 includes the variable named “mtpID” that was previously described above. The same entity owns the publishing rights to a song for every master audio recording of that song. Thus, when different master audio recordings of the same song are added to the music setlist 902, the publishing identifiers 914 of each master audio recordings will indicate the same entity, but the master identifier 912 of one of the master audio recording may indicate a different entity than the master identifier 912 of the other master audio recording.

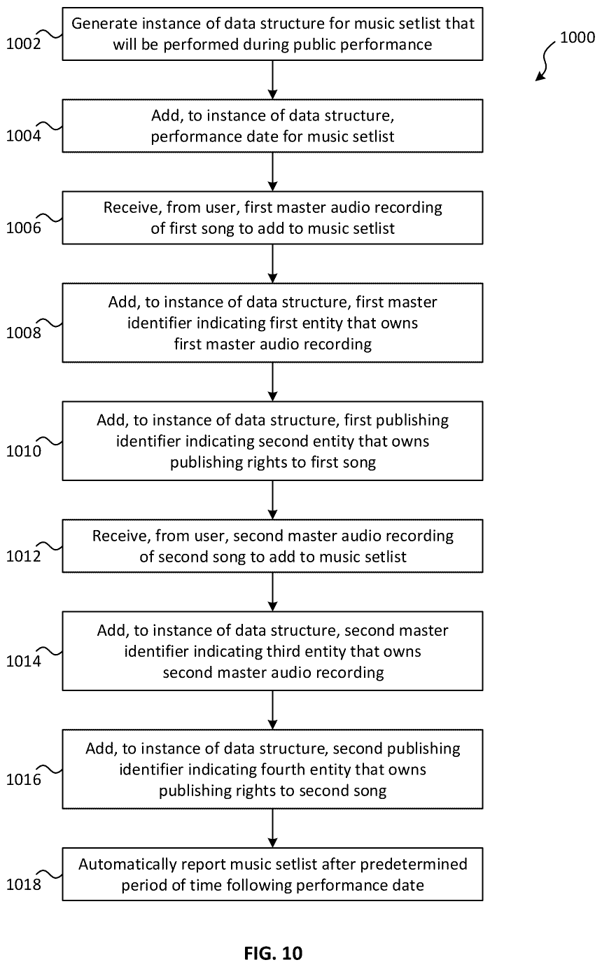

FIG. 10 is a flow diagram of an example of a method 1000 for auto-reporting public music performances. The method 1000 is performed by processing logic that may include hardware (circuitry, dedicated logic, etc.), software (such as is run on a general-purpose computer system, a dedicated machine, or a computing device of any kind (e.g., IoT node, wearable, smartphone, mobile device, etc.)), or a combination of both. The method 1000 and/or each of its individual functions (including “methods,” as used in object-oriented programming), routines, subroutines, or operations may be performed by one or more processors of a computing device (e.g., any component of FIG. 7, as described above). In certain implementations, the method 1000 may be performed by a single processing thread. Alternatively, the method 1000 may be performed by two or more processing threads, wherein each thread implements one or more individual functions, routines, subroutines, or operations of the method 1000.

For simplicity of explanation, the method 1000 is depicted in FIG. 10 and described as a series of operations. However, operations in accordance with the present disclosure can occur in various orders and/or concurrently, and/or with other operations not presented and described herein. For example, the operations depicted in the method 1000 in FIG. 10 may occur in combination with any other operation of any other method disclosed herein. Furthermore, not all illustrated operations may be required to implement the method 1000 in accordance with the disclosed subject matter. In addition, those skilled in the art will understand and appreciate that the method 1000 could alternatively be represented via a state diagram or event diagram as a series of interrelated states.

At block 1002, an instance of a data structure is generated for a music setlist that will be performed during a public performance. At block 1004, a performance date for the music setlist is added to the instance of the data structure. In some implementations, a user provides the performance date for the music setlist. For example, the user may provide the performance date via a user interface. Alternatively, or in addition, the performance date may be set based on a service type associated with a music setlist. For example, the performance date may be set to the date of the upcoming Sunday when the music setlist is tagged as a Sunday morning service.

At block 1006, a first master audio recording of a first song to add to the music setlist is received from a user. At block 1008, a first master identifier indicating a first entity that owns the first master audio recording is added to the instance of the data structure. At block 1010, a first publishing identifier indicating a second entity that owns publishing rights to the first song is added to the instance of the data structure. At block 1012, a second master audio recording of a second song to add to the music setlist is received from the user. At block 1014, a second master identifier indicating a third entity that owns the second master audio recording is added to the instance of the data structure. At block 1016, a second publishing identifier indicating a fourth entity that owns publishing rights to the second song is added to the instance of the data structure.

At block 1018, the music setlist is automatically reported after a predetermined period of time following the performance date. For example, the music setlist may be automatically reported two weeks after the performance date. In some implementations, the music setlist is automatically reported by generating a record updated as previously described above. Alternatively, or in addition, the music setlist may be reported by sending (or transmitting) the instance of the data structure from one electronic device to another. For example, the instance of the data structure for the music setlist may be sent from the electronic user device 702 to the server 704, or sent from the server 704 to the database 706. Alternatively, or in addition, the music setlist may be reported by setting or changing the value of a variable in the data structure. For example, the data structure may include a reported variable that is changed from false to true when the music setlist is reported. After the reported variable is changed to true, the music setlist is locked and no changes can be made. In this manner, the music usage reporting system may read the data structure of the music setlist for reporting purposes at a later date. For example, the music usage reporting system may gather the last three months of song scheduling data from reported music setlists in order to report payments to the publishers and owners of the content.

In some implementations, one or more of the master audio recordings include a multitracks recording. A multitracks recording includes all of the individual elements of an audio production, each with their own dedicated track (or stem). For example, a multitrack recording may include an electric guitar track, a vocals track, a piano track, a bass track, and an acoustic guitar track. During some public performances, some or all of the songs may be played by a combination of live instruments, live singers, and one or more stems from a multitrack recording. For example, a multitrack recording of a song may be played without the bass track (i.e., the bass track is muted) because a live bass is playing. As a further example, a multitrack recording of a song may be played without the vocals track (i.e., the vocals track is muted) because a live choir is singing. In some implementations, the data structure for a music setlist includes one or more indicators that indicator which tracks (or stems) of a multitracks recording will be played during a public performance.

Consistent with the above disclosure, the examples of systems and methods enumerated in the following clauses are specifically contemplated and are intended as a non-limiting set of examples.

Clause 1. A method for auto-reporting public music performances, the method comprising:
generating an instance of a data structure for a music setlist that will be performed during a public performance;
adding, to the instance of the data structure, a performance date for the music setlist;
receiving, from a user, a first master audio recording of a first song to add to the music setlist;
adding, to the instance of the data structure, a first master identifier indicating a first entity that owns the first master audio recording;
adding, to the instance of the data structure, a first publishing identifier indicating a second entity that owns publishing rights to the first song;
receiving, from the user, a second master audio recording of a second song to add to the music setlist;
adding, to the instance of the data structure, a second master identifier indicating a third entity that owns the second master audio recording;
adding, to the instance of the data structure, a second publishing identifier indicating a fourth entity that owns publishing rights to the second song; and
automatically reporting the music setlist after a predetermined period of time following the performance date.

Clause 2. The method of any clause herein, further comprising locking the music setlist to prevent changes after the music setlist is reported.

Clause 3. The method of any clause herein, further comprising:
receiving, from the user, a third master audio recording of the first song to add to the music setlist;
adding, to the instance of the data structure, a third master identifier indicating a fifth entity that owns the third master audio recording; and
adding, to the instance of the data structure, a third publishing identifier indicating the second entity that owns the publishing rights to the first song.

Clause 4. The method of any clause herein, wherein the music setlist further includes an indication of whether song lyrics will be displayed during the public performance.

Clause 5. The method of any clause herein, wherein the indication further indicates whether the song lyrics will be projected or printed.

Clause 6. The method of any clause herein, wherein the music setlist further includes an indication of whether the public performance will be steamed online.

Clause 7. The method of any clause herein, wherein automatically reporting the music setlist further includes generating a record update based on the instance of the data structure.

Clause 8. The method of any clause herein, when the instance of the data structure further includes an identifier of an organization associated with the public performance, wherein generating the record update further includes determining a size of the organization based on the identifier of the organization.

Clause 9. The method of any clause herein, wherein the first master audio recording includes a plurality of stems.

Clause 10. The method of any clause herein, wherein the first master audio recording includes a multitrack recording.

Clause 11. A system for auto-reporting public music performances, the system comprising:
one or more memory devices for storing instructions; and
one or more processing devices configured to execute the instructions to:
   generate an instance of a data structure for a music setlist that will be performed during a public performance,
   add, to the instance of the data structure, a performance date for the music setlist,
   receive, from a user, a first master audio recording of a first song to add to the music setlist,
   add, to the instance of the data structure, a first master identifier indicating a first entity that owns the first master audio recording,
   add, to the instance of the data structure, a first publishing identifier indicating a second entity that owns publishing rights to the first song,
   receive, from the user, a second master audio recording of a second song to add to the music setlist,
   add, to the instance of the data structure, a second master identifier indicating a third entity that owns the second master audio recording,
   add, to the instance of the data structure, a second publishing identifier indicating a fourth entity that owns publishing rights to the second song, and
   automatically report the music setlist after a predetermined period of time following the performance date.

Clause 12. The system of any clause herein, wherein the one or more processing devices are further to execute the instructions to lock the music setlist to prevent changes after the music setlist is reported.

Clause 13. The system of any clause herein, wherein the one or more processing devices are further to execute the instructions to:
receive, from the user, a third master audio recording of the first song to add to the music setlist,
add, to the instance of the data structure, a third master identifier indicating a fifth entity that owns the third master audio recording, and
add, to the instance of the data structure, a third publishing identifier indicating the second entity that owns the publishing rights to the first song.

Clause 14. The system of any clause herein, wherein the music setlist further includes an indication of whether song lyrics will be displayed during the public performance.

Clause 15. The system of any clause herein, wherein the indication further indicates whether the song lyrics will be projected or printed.

Clause 16. The system of any clause herein, wherein the music setlist further includes an indication of whether the public performance will be steamed online.

Clause 17. The system of any clause herein, wherein, to automatically report the music setlist, the one or more processing devices are further configured to execute the instructions to generate a record update based on the instance of the data structure.

Clause 18. The system of any clause herein, when the instance of the data structure further includes an identifier of an organization associated with the public performance, wherein, to generate the record update, the one or more processing devices are further configured to execute the instructions to determine a size of the organization based on the identifier of the organization.

Clause 19. The system of any clause herein, wherein the first master audio recording includes a plurality of stems.

Clause 20. The system of any clause herein, wherein the first master audio recording includes a multitrack recording.

For simplicity of explanation, the methods described herein are depicted and described as a series of operations. However, operations in accordance with this disclosure can occur in various orders and/or concurrently, and/or with other operations not presented and described herein. For example, the operations depicted in one method described herein may occur in combination with any other operation of any other method disclosed herein. Furthermore, not all illustrated operations may be required to implement the methods described herein in accordance with the disclosed subject matter. In addition, those skilled in the art will understand and appreciate that the methods described herein could alternatively be represented via a state diagram or event diagram as a series of interrelated states.

The foregoing description, for purposes of explanation, use specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various implementations of the present disclosure. Once the above disclosure is fully appreciated, numerous variations and modifications will become apparent to those skilled in the art.

What is claimed is:

1. A method for auto-reporting public music performances, the method comprising:
generating an instance of a data structure for a music setlist that will be performed during a public performance;
adding, to the instance of the data structure, a performance date for the music setlist;
receiving, from a user, a first master audio recording of a first song to add to the music setlist;
adding, to the instance of the data structure, a first master identifier indicating a first entity that owns the first master audio recording;
adding, to the instance of the data structure, a first publishing identifier indicating a second entity that owns publishing rights to the first song;
receiving, from the user, a second master audio recording of a second song to add to the music setlist;
adding, to the instance of the data structure, a second master identifier indicating a third entity that owns the second master audio recording;
adding, to the instance of the data structure, a second publishing identifier indicating a fourth entity that owns publishing rights to the second song; and
automatically reporting the music setlist after a predetermined period of time following the performance date.

2. The method of claim 1, further comprising locking the music setlist to prevent changes after the music setlist is reported.

3. The method of claim 1, further comprising:
receiving, from the user, a third master audio recording of the first song to add to the music setlist;
adding, to the instance of the data structure, a third master identifier indicating a fifth entity that owns the third master audio recording; and
adding, to the instance of the data structure, a third publishing identifier indicating the second entity that owns the publishing rights to the first song.

4. The method of claim 1, wherein the music setlist further includes an indication of whether song lyrics will be displayed during the public performance.

5. The method of claim 4, wherein the indication further indicates whether the song lyrics will be projected or printed.

6. The method of claim 1, wherein the music setlist further includes an indication of whether the public performance will be steamed online.

7. The method of claim 1, wherein automatically reporting the music setlist further includes generating a record update based on the instance of the data structure.

8. The method of claim 7, when the instance of the data structure further includes an identifier of an organization associated with the public performance, wherein generating the record update further includes determining a size of the organization based on the identifier of the organization.

9. The method of claim 1, wherein the first master audio recording includes a plurality of stems.

10. The method of claim 1, wherein the first master audio recording includes a multitrack recording.

11. A system for auto-reporting public music performances, the system comprising:
one or more memory devices for storing instructions; and
one or more processing devices configured to execute the instructions to:
generate an instance of a data structure for a music setlist that will be performed during a public performance,
add, to the instance of the data structure, a performance date for the music setlist,
receive, from a user, a first master audio recording of a first song to add to the music setlist,
add, to the instance of the data structure, a first master identifier indicating a first entity that owns the first master audio recording,
add, to the instance of the data structure, a first publishing identifier indicating a second entity that owns publishing rights to the first song,
receive, from the user, a second master audio recording of a second song to add to the music setlist,
add, to the instance of the data structure, a second master identifier indicating a third entity that owns the second master audio recording,
add, to the instance of the data structure, a second publishing identifier indicating a fourth entity that owns publishing rights to the second song, and
automatically report the music setlist after a predetermined period of time following the performance date.

12. The system of claim 11, wherein the one or more processing devices are further to execute the instructions to lock the music setlist to prevent changes after the music setlist is reported.

13. The system of claim 11, wherein the one or more processing devices are further to execute the instructions to:
receive, from the user, a third master audio recording of the first song to add to the music setlist,
add, to the instance of the data structure, a third master identifier indicating a fifth entity that owns the third master audio recording, and
add, to the instance of the data structure, a third publishing identifier indicating the second entity that owns the publishing rights to the first song.

14. The system of claim 11, wherein the music setlist further includes an indication of whether song lyrics will be displayed during the public performance.

15. The system of claim 14, wherein the indication further indicates whether the song lyrics will be projected or printed.

16. The system of claim 11, wherein the music setlist further includes an indication of whether the public performance will be steamed online.

17. The system of claim 11, wherein, to automatically report the music setlist, the one or more processing devices are further configured to execute the instructions to generate a record update based on the instance of the data structure.

18. The system of claim 17, when the instance of the data structure further includes an identifier of an organization associated with the public performance, wherein, to generate the record update, the one or more processing devices are further configured to execute the instructions to determine a size of the organization based on the identifier of the organization.

19. The system of claim 11, wherein the first master audio recording includes a plurality of stems.

20. The system of claim 11, wherein the first master audio recording includes a multitrack recording.
